(19) United States
(12) Patent Application Publication
(10) Pub. No.: US 2019/0105757 A1
(43) Pub. Date: Apr. 11, 2019

(54) MULTIPLE FUNCTION TOOL APPARATUS

(71) Applicant: Clifton Jackson, Arlington, TX (US)

(72) Inventor: Clifton Jackson, Arlington, TX (US)

(21) Appl. No.: 16/155,520

(22) Filed: Oct. 9, 2018

Related U.S. Application Data
(60) Provisional application No. 62/569,665, filed on Oct. 9, 2017.

(51) Int. Cl. B25B 7/10; B25B 7/22; B25B 7/18

(52) U.S. Cl. CPC B25B 7/10; B25B 7/18; B25B 7/22

(57) ABSTRACT

A multiple function tool apparatus facilitates the use of a plyer style tool in a wider range of areas and spaces than conventional plyer devices. Additional tools are attached to the arms of the tool to simplify tasks such as preparing wires, installing fasteners and the like.

### BACKGROUND

### 1. Field of the Invention

The present invention relates generally to hand tools, and more specifically, to a multiple function tool apparatus for facilitating the manipulation of wires, fasteners or the like.

### 2. Description of Related Art

Hand tools are well known in the art and are effective means to facilitate performing manual tasks such as installing fasteners, altering material or the like. For example, FIG. 1 depicts a conventional plyer device 101 having a first arm 103 and a second arm 105 rotationally attached via a pin 107. Arm 103 and 105 each having a grip end and a handle end opposite each other. During use, the arms 103, 105 rotate with respect to each other to open a space between the grip ends. The grip ends secure around an object and the handle ends are pushed towards each other to hold on to the object.

One of the problems commonly associated with system 101 is its limited use. For example, the manipulation of the arms 103, 105 requires space equal to the radius of the handle ends to fully open the grip ends and force is required to both open and close the arms 103, 105 limiting the situations when the plyer device 101 can be used.

Accordingly, although great strides have been made in the area of plyer devices, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a common plyer device;

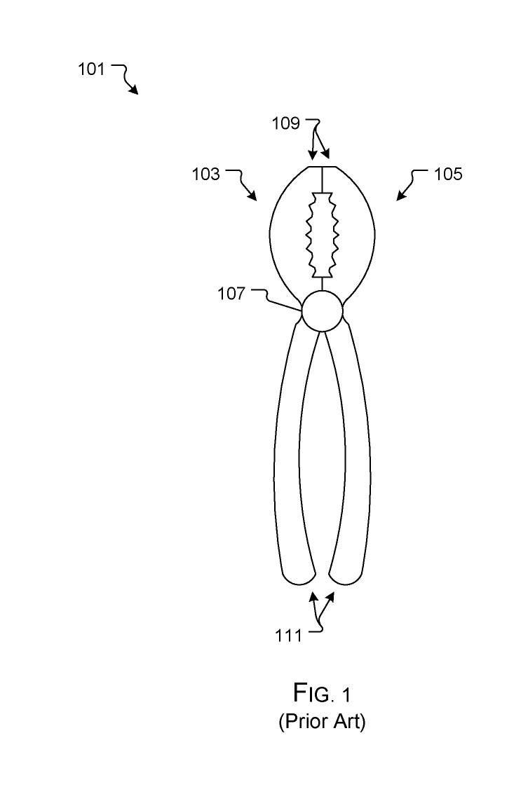

FIG. 2 is a side view of a multiple function tool apparatus in accordance with a preferred embodiment of the present application;

FIG. 3 is a side view of the spring of FIG. 2; and

FIGS. 4A and 4B are side views of the system of FIG. 2 is use.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional filtration systems. Specifically, the invention of the present application reduces the space required for use allowing the access to additional areas. In addition, force is only required to compress the tool further simplifying the its use. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

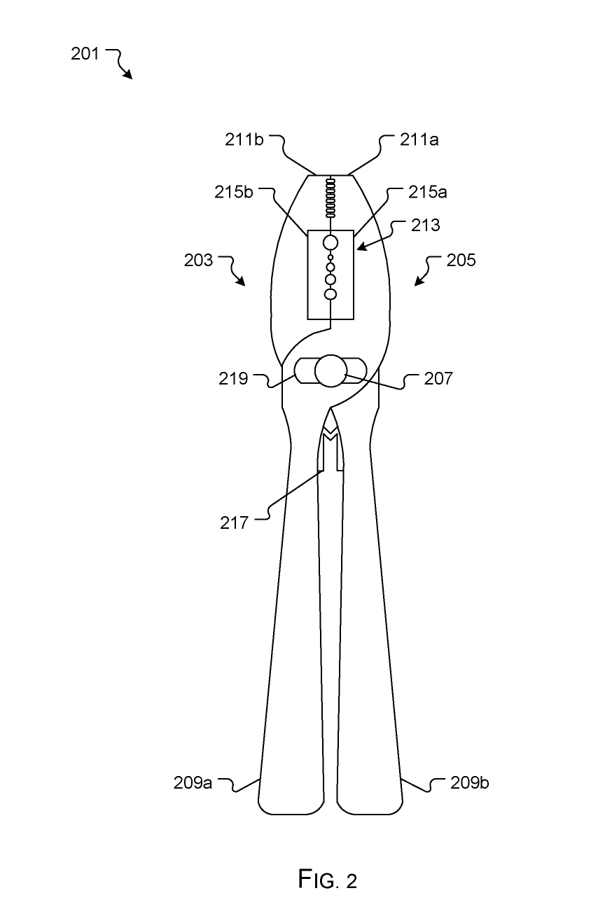

Referring now to the drawings wherein like reference characters identify corresponding or similar elements throughout the several views, FIG. 2 depicts a side view of a multiple function tool apparatus in accordance with a preferred embodiment of the present application. It will be appreciated that system 201 overcomes one of more of the above-listed problems commonly associated with conventional plyer devices.

In the contemplated embodiment, apparatus 201 includes a first arm 203 and a second arm 205 slidingly attached via a pin 207 and a slot 219. An M-spring 217 is attached between the two arms 203, 205 below the pin 207. Each of the arms 203, 205 having a handle portion 209 and a jaw portion 211. The jaw portion 211 configured to grip objects. The apparatus 201 having at least one additional tool 213 attached to the arms 203, 205. In the current embodiment 201 each of the arms 203, 205 has a half of a wire tool 215 integral to the jaw portion 211.

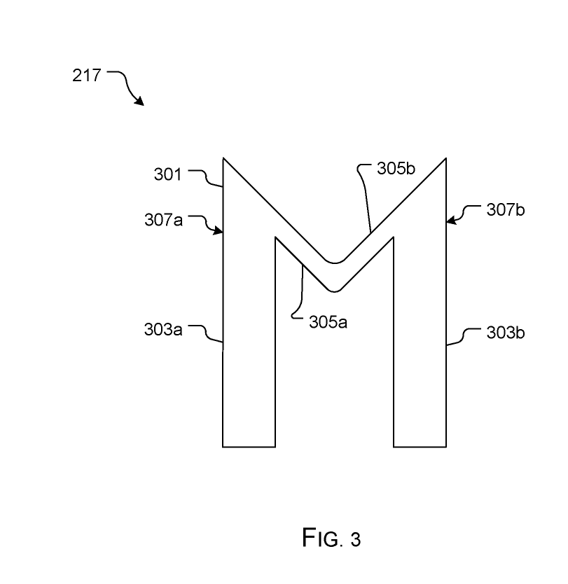

Referring now to FIG. 3 the M-spring 217 is depicted. M-spring 217 including a body 301 having bases 303 each with a leverage member 305 attached to a first end 307 and extending way at an acute angle. While it is depicted that leverage members 305 are joined it is contemplated that they could be separate and attached at a point on the arms 203, 205.

It should be appreciated that one of the unique features believed characteristic of the present application is that M-spring 217 and slot 219 enable the arms 203, 205 to expand without the use of force as a well as open in a smaller amount of space.

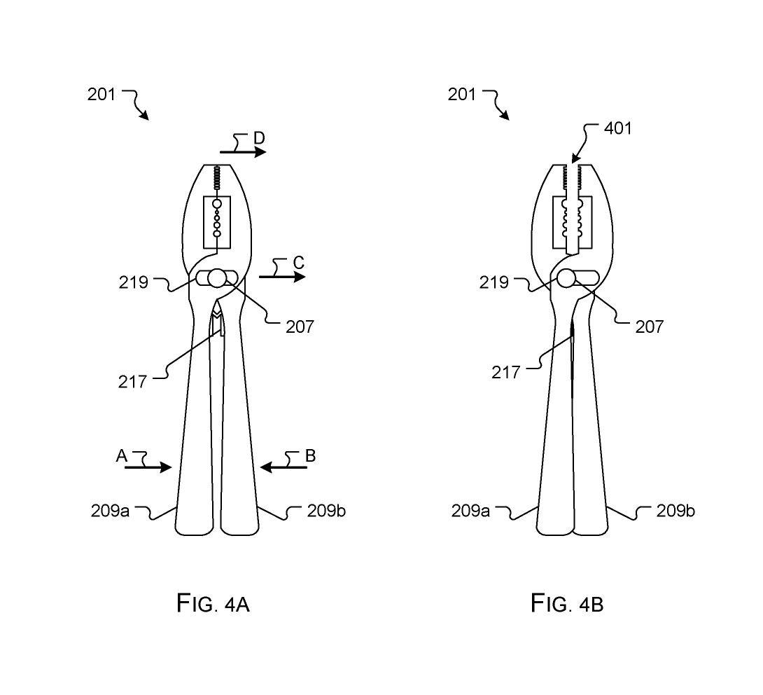

Referring now to FIGS. 4A and 4B, the system 201 is depicted in use. Force is applied to the handle portions 209 as depicted by motions A and B so that the pin 207 traverses the slot 207 depicted by motion C allowing the jaw portions 211 to open depicted by motion D and create a space 401 therebetween without rotation of the handle portions 209.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A multiple function tool apparatus comprising:
two arms slidingly attached via a pin and slot;
the arms having a handle portion and an jaw portion;
at least one m-spring attached to the handle portions of the arms below the pin; and
at least one additional tool attached to at least one of the arms;
wherein objects are griped between the jaw portions of the arms; and
wherein the m-spring causes the handle portions of the arms to move away from each other.

2. The apparatus of claim 1 wherein the additional tool is a wire tool having a half attached to each of the arms in the jaw portion.
